(19) United States
(12) Patent Application Publication
(10) Pub. No.: US 2020/0120223 A1
(43) Pub. Date: Apr. 16, 2020

(54) SYSTEMS, PROCESSES, AND COMPUTER PROGRAM PRODUCTS FOR CUSTOMIZED PRINTING OF PAGE SHAPE FROM SCANNED DATA

(71) Applicant: KYOCERA Document Solutions Inc., Osaka (JP)

(72) Inventor: Samantha Tong, Walnut Creek, CA (US)

(21) Appl. No.: 16/156,919

(22) Filed: Oct. 10, 2018

(51) Int. Cl. H04N 1/00; H04N 1/387; H04N 1/393; G06F 3/12

(52) U.S. Cl. CPC H04N 1/00482; H04N 1/3877; H04N 1/393; G06F 3/1257; H04N 1/00567; G06F 3/1205; H04N 1/00474

(57) ABSTRACT

A system and process are disclosed which provide users with a user-defined or custom-shaped print job from scanned data. A document may be scanned and an image object may be extracted from the scanned data which may be used as a print template from which the shape of a cut page is formed. Text and/or graphics may be applied to the page space occupied by the page shape area that will be cut. In an exemplary embodiment, the text and/or graphics may be automatically scaled or sized to fit within the boundary of the print template area. Once the page is cut, the text and/or graphics will automatically fit within the page's shape.

### CROSS-REFERENCE TO RELATED APPLICATION

None.

### FIELD

The subject disclosure relates to printing and more particularly to systems, processes, and computer program products for customized printing of page shape from scanned data.

### BACKGROUND

Conventional printing includes printing on to one of a number of standardized sized and rectangularly shaped sheets of paper. This can be limiting in the industry because creative fields have wanted for a long time to print out customized shaped pages of materials. For example, marketing tools may sometimes want to stand out by generating business cards, flyers, brochures or the like in non-standard page form. To do so under conventional tools requires a lot of labor. Generally, an image is printed onto a standard rectangular sheet of paper. Sometimes the image doesn't fit the sheet of paper so a non-standard size paper must be located. The problems become compounded when trying to customize a message or graphic onto the non-standard paper. The print text or graphic must be manually manipulated somehow to fit correctly onto the end product. Currently there are no tools that allow one to adjust text or graphics onto an undefined paper size. Once printed out on standard size paper, the paper is manually cut to provide the desired shape. Conventionally, an individual cuts the desired shape around a section of the paper including text or graphics. As may be appreciated, this is both time consuming and wasteful.

As can be seen, there is a need for electronically producing pages in non-standard shapes with text or graphics included.

### SUMMARY

In one aspect of the disclosure, a method of customizing a shape of a print job using a shape from a scanned document, by a computer processor is disclosed. The method comprises receiving, by the computer processor, scan data of the scanned document; extracting, by the computer processor, an object shape from the received scan data; saving, by the computer processor, the object shape as a print template; receiving, by the computer processor, text or a graphic; automatically sizing, by the computer processor, the text or graphic to fit within a boundary defined by a size of the print template; sending, by the computer processor, the print template, including the automatically sized text or graphic, to a computer operated print cutting unit; cutting, by the computer operated print cutting unit, the print template from a medium, resulting in a cut page shape, wherein the cut page shape includes the automatically sized text or graphic within a perimeter of the cut page shape; and outputting the cut page shape from the cutting unit.

In another aspect, a computer program product for customizing a shape of a print job using a shape from a scanned document is disclosed. The computer program product comprises a non-transitory computer readable storage medium having computer readable program code embodied therewith. The computer readable program code is configured, when executed by a computer processor, to: receive, by the computer processor, scan data of the scanned document; extract, by the computer processor, an object shape from the received scan data; save, by the computer processor, the object shape as a print template; receive, by the computer processor, text or a graphic; automatically size, by the computer processor, the text or graphic to fit within a boundary defined by a size of the print template; send, by the computer processor, the print template, including the automatically sized text or graphic, to a computer operated print cutting unit; cut, by the computer operated print cutting unit, the print template from a medium, resulting in a cut page shape, wherein the cut page shape includes the automatically sized text or graphic within a perimeter of the cut page shape; and output the cut page shape from the cutting unit.

In yet another aspect, a multi-function device is disclosed. The device comprises an electronic memory; one or more cassette trays for holding a print medium; an electronic scanner; a cutting unit configured to cut a unit of the print medium; a feeder coupled to the one or more cassette trays and configured to feed the print medium to the cutting unit; and a computer processor coupled to the electronic memory, the electronic scanner, the cutting unit, and the feeder, wherein the computer processor is configured, when executed by instructions provided by the electronic memory, to: receive, by the computer processor, scan data of the scanned document; extract, by the computer processor, an object shape from the received scan data; save, by the computer processor, the object shape as a print template; receive, by the computer processor, text or a graphic; automatically size, by the computer processor, the text or graphic to fit within a boundary defined by a size of the print template; send, by the computer processor, the print template, including the automatically sized text or graphic, to a computer operated print cutting unit; cut, by the computer operated print cutting unit, the print template from a medium, resulting in a cut page shape, wherein the cut page shape includes the automatically sized text or graphic within a perimeter of the cut page shape; and output the cut page shape from the cutting unit.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a flowchart of a method of customizing a print job's shape and production from scanned data in accordance with an embodiment of the subject technology.

FIG. 2 is a front view of a folded, custom shaped cut page produced in accordance with an embodiment of the subject technology.

FIG. 2A is a front view of the custom shaped page of FIG. 2, unfolded showing an interior page side.

FIG. 3 is a schematic of a print job system in accordance with an embodiment of the subject technology.

FIG. 4 is a block diagram of an image forming apparatus in accordance with an embodiment of the subject technology.

FIG. 5 is a block diagram of a computing device in accordance with an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

Embodiments disclosed below may be practiced in and have industrial applicability to the general fields of printing, publications, and promotional product manufacturing.

Generally, embodiments of the subject technology invention provide computer implemented methods and printing technology that allow users the ability to mass produce customized shaped and/or sized pages of printed material. In some aspects, a page shape may be extracted from an image design in a scanned document or from a document (or object) that is already in the desired custom shape. Scanning a document to get a specific size or shape will be beneficial for individuals who engage in creative projects including, for example, marketing/sales purposes. With the use of the scanner the user does not need to specify the size and shape of the document they want. Aspects of the processes disclosed below may reproduce the design from the scanned document and automatically replicate the design shape/size as a finished page with text and/or graphics.

As used below, a “page” may refer to a sheet of paper, a digital representation of a sheet, or another medium onto which printing may be performed. Generally speaking, the “page space” may refer to the available printing area onto which images may be placed and fit within the borders for a size of paper (or other printing medium). According to embodiments described below, the “page space” may be transformed from a rectangular area (from which scanned data may be extracted from) into an arbitrarily shaped page (for example, a non-standard sized rectangular or a non-rectangular sheet of paper (or other print medium)). As will be further appreciated, in some aspects the design may be scanned from an arbitrarily shaped image, an arbitrarily shaped document, or another source object and still converted into a non-rectangular page as a finished product.

In some embodiments, the digital representation of the page space may exist as a digital file to be transferred between computing devices and displayed on an electronic display. The page space may in some embodiments exist as an electronic file whose display shows a digital preview of the finished printed page under the embodiments disclosed below or may be rendered onto a recording medium such as paper (or another tangible substrate onto which an image object may be rendered) as described further below.

In addition, a “print job” may refer to a single page with multiple images and/or text contained within its borders. As used below, a “print job” may sometimes be referred to as an image object since the rendering of the print job is shown as an image representing a print template within the page space before being printed and/or cut.

For the following flowchart, steps of the processes may be referred to as blocks and/or by reference numeral shown in parentheses. As will be described further below, steps may be performed by a machine, for example, a computing device, an image forming apparatus, and/or a processing unit. While the steps may be described in one order, it will be understood that variations to the order may be practiced or the order in which claims below are written may vary from the following without departing from the scope of the invention.

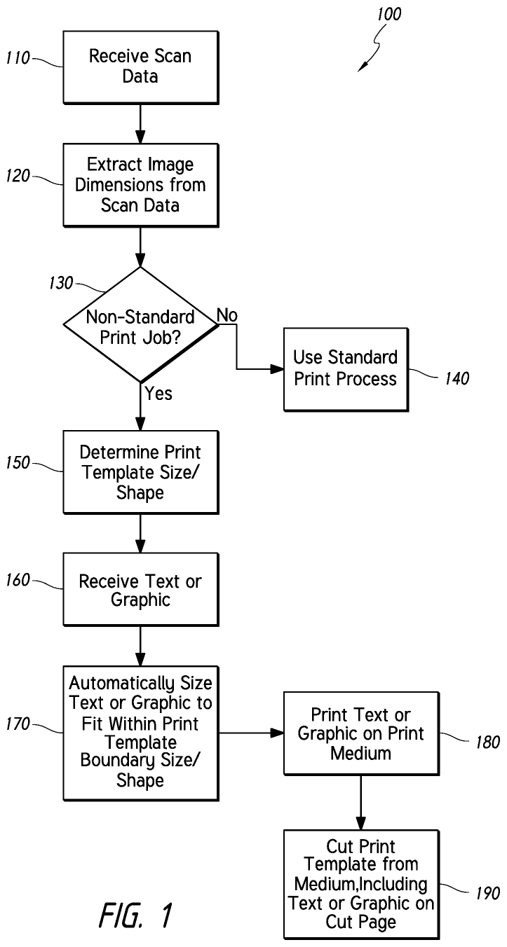

Referring now to FIG. 1, a method 100 of customizing a print job's shape and production from scanned data is shown according to an exemplary embodiment. The method 100 may produce as a finished product, for example, a printed sheet of paper that is cut according to the shape of a scanned object as obtained from scanned data. In an exemplary embodiment, the method 100 may is performed by hardware according to computer executable instructions (executed by a computer processor described below) in the form of a software application or a device driver.

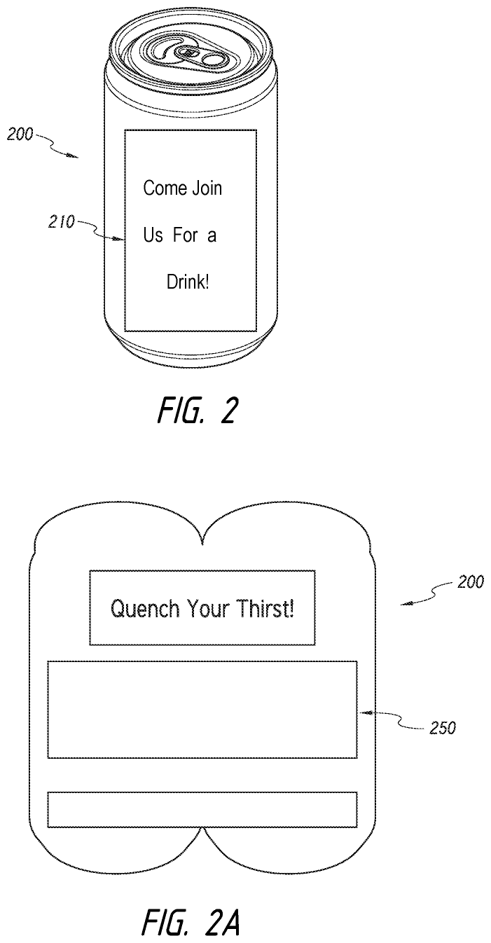

In block 110, scan data of a scanned document (or object) may be received. For example, a user may wish to replicate an image within a document's border into the shape of a printed page. The user may scan the document and its data is received by the device performing the conversion of the image into a page shape. In some embodiments, should the scanned document include more than one image, the user may select an image as the object to be replicated into a page shape. Some embodiments may include optical character recognition (OCR) and image segmentation to identify and distinguish between various objects in a scan. Some embodiments may include a feature in a user interface which the user controls to select and/or outline the shape of the object or image being used to define the resultant page shape. In some embodiments, a multi-function device which may include for example, a scanner, a printer, and/or a cutting unit (described more fully below with respect to FIG. 2) may be used. Accordingly, in some embodiments, the scanned data may be received from the scanning unit of the multi-function device, which is then forwarded to a central processing unit or processor.

In block 120, the image dimensions may be extracted from the scan data. The dimensions may include the image object size and outline (perimeter points). In addition, other elements including for example, text or graphics within the outline of the image object may be extracted (for example, by use of OCR or image segmentation).

In block 130, the method may determine whether the print job is standard or non-standard. If the print job is a standard print job (for example, a rectangular sheet using an industry standard size or a size saved in printer settings), then the method may use, in block 140, a standard print process.

In block 150, for non-standard print jobs, customized, or user-defined print jobs, the print job size and/or shape may be determined from the scanned data. The image object's perimeter points may be recorded to measure the area encompassed by the image object. In some embodiments, finished product may have the same size as the scanned image object. The driver may automatically resize the image to produce the defined print job so that the image is within the printable area as defined by the scanned image. In some embodiments, a user control function allows the user should to resize the image to best suit their needs. The page shape may be based on a line(s) along the non-rectangular perimeter of the image object. The attributes from the image dimensions (and any text or graphics) may be saved as a print template used to generate the finished page shape that is printed out.

In block 160, some embodiments may include a feature which allows the user to insert text or graphics (which may differ from any text or graphics extracted from the scan data) that may be included within the finished page. For example, in the context of producing a marketing advertisement, a beverage container may be used as the outline for a customized shape generated by the process described. The user of the process may enhance the end product by using a saved text file or graphics file which, through a user interface, may be applied to a print preview of the print template. In one embodiment, for example, a field is created in the scanned area that may be a non-standard shape (depending on the scanned shape) and then the text and/or graphic may automatically be positioned in the area by the program's process. The user then has to option to go with the computer generated print job or redefine the positioning of the text and/or graphic by user control.

In block 170, the text or graphics may be automatically sized to fit within the print template space. The dimensions of the print template may be compared to the area/size of the text or graphics. If the area/size of the text or graphics exceeds the boundaries of the print template, then the area/size of the text or graphics may be shrunk until it fits within a set distance from the boundary. The amount of space covered may first be generated as a suggestion by the program process. In some embodiments, the user may be provided an option to redefine the size/shape/positioning of the text and/or graphic through a user interface.

In block 180, some embodiments may send the print template to a printer for printing. For example, if text or graphics are to be inserted prior to the print medium being cut, then the text or graphics are printed onto the print medium first and then the printed on medium may be sent to the cutting unit to cut the page shape from the print medium with the text or graphics within the page shape border. In some embodiments, the printer may be selected based on the size of the print job. In an exemplary embodiment, the process may determine which size sheet of paper is large enough to fit a printed copy of the image object (or print template) with the least amount of unused page space. The method 100 may select a printer cassette tray with the determined sheet size and send the print job file to the printer with the selected cassette tray.

In block 190, a cutting unit coupled to the printer may cut the printing medium according to the print template shape. In an exemplary embodiment, the cutting results in a cut page shape that replicates the scanned document or scanned object. The cut page shape may also include the automatically sized text or graphic within a perimeter of the cut page shape. In some embodiments, where the print template is sent to the cutting unit without printing being involved, a cassette tray coupled to the cutting unit (from among a plurality of cassette trays), may be selected based on the size of the print medium closest to the size of the cut, shaped page.

FIGS. 2 and 2A show an example of a customized page 200 produced for example, by the process disclosed above in FIG. 1. The page 200 is an arbitrarily shaped page that replicates the shape of a soda can. In FIG. 2, the page 200 is shown folded so that an exterior facing page face 210 resembles an unopened can of soda. Text and/or graphics may be printed on the exterior facing page (as shown in FIG. 2). As will be appreciated, aspects of the technology may print and cut out the finished article so that it appears to be three dimensional in the illustrations. However, while the printed straight lines and curved lines may provide the appearance of three dimensionality, it will be understood that the actual finished article may typically be a paper product and may have only a nominal thickness. In FIG. 2A, the page 200 is unfolded to reveal text and/or graphics on an interior facing page face 250. As may be appreciated, the page 200 includes a perimeter with a combination of straight edges, curved edges, and recesses. The perimeter of the page 200 may be formed automatically based on scanned data. The scanned data may be translated into a print template which is used by a cutting machine to produce the finished cut page shape. In some embodiments, the text and/or graphics are automatically sized to fit within the edges of the cut page as described above with respect to FIG. 1.

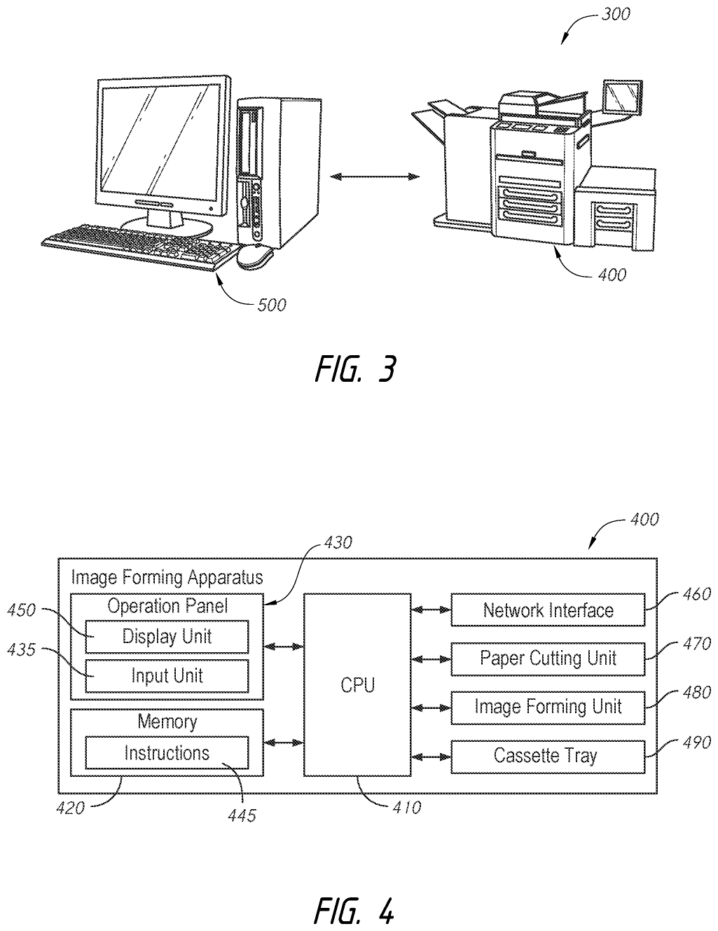

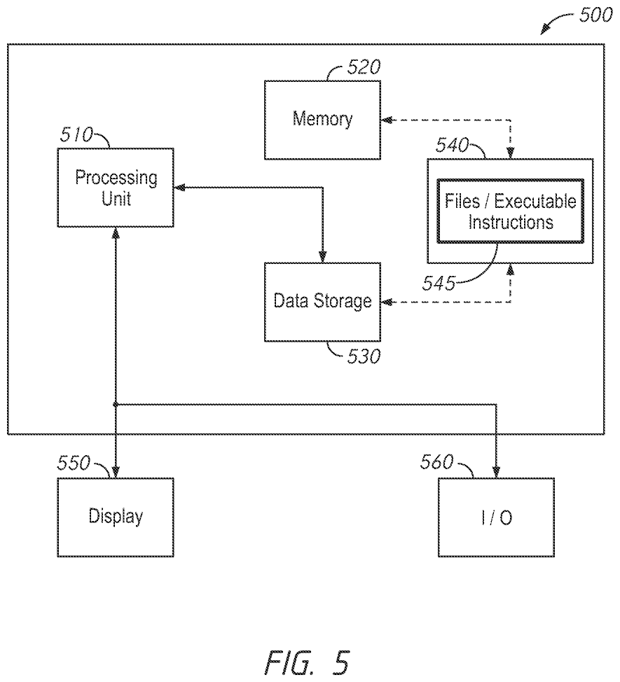

Referring now to FIGS. 3-5, a system and machines of the subject technology are shown according to exemplary embodiments. A system 300 is shown in FIG. 3 which may include an image forming apparatus 400 connected to a computing device 500. In some embodiments, the above described process(es) may be loaded as executable instructions into one or both of the image forming apparatus 400 and the computing device 500. FIG. 4 shows a schematic example of the image forming apparatus 400. FIG. 5 shows a schematic example of a computing device 500. In general, the process(es) above may be implemented by either or both the image forming apparatus 400 and the computing device 500. In addition, it will be understood that multiple instances of the computing device 500 may be connected to the same image forming apparatus 400, however, for sake of illustration, a single computing device 500 is shown. In an exemplary operation, a computing device(s) 500 may send scanned data to the image forming apparatus 400.

The image forming apparatus 400 may be for example, a computing-based image processing and printing device (for example, a printer, a fax machine, a copier machine, a multi-function printer that may include a combination of these plus a scanner and/or a cutting unit 470). In an exemplary embodiment, the image forming apparatus 400 is a multi-function device that includes at least a scanner and a cutting unit 470. In some embodiments, the processes described above may be fully produced by the image forming apparatus 400 because the apparatus may include a scanner, printer and cutting unit in the same housing.

The components of the image forming apparatus 400, may include, but are not limited to, one or more processors or processing units 410, a system memory 420, an operation panel 430, an input unit 435, a set of program modules 445 including files and executable instructions, a display unit 450, a network interface 460, a paper cutting unit 470, an image forming unit 480, and a bus system that couples various system components including the system memory 420 to the processor(s) 410. The memory storage 420 may store for example, executable instructions and/or electronic versions of the image objects to be printed. In some embodiments, the processors 410 may include a processing unit dedicated to graphics and image processing (for example a graphics processing unit (GPU) or visual processing unit (VPU). As a GPU or VPU, the processor 410 may implement executable instructions focused on image processing applications (like those related to rendering the image objects into print jobs on the page space described above) either alone or in coordination with other general processor 410 types such a CPUs, microchips, and the like. The input unit 435 may be for example, a scanner or I/O port receiving data from a computing device 500. In some embodiments, operation of the image forming unit may be controlled by a user interface accessed by either the operation panel 430 on the apparatus or through a user interface displayed via a program module 445 through a user's computing device that is connected to the apparatus 400. The user interface may include print settings that include for example, a sheet size of the print medium to be printed on/cut into a page shape. The sheet size may be any standard sheet size used in the industry loaded into a cassette tray 490. The sheet size settings may be stored as pre-determined sizes in memory. In some embodiments, the apparatus 400 may include multiple cassette trays 490. One cassette tray 490 may store a different print medium sheet size than another cassette tray 490. In a process of selecting a print medium sheet size for a print job, the process may evaluate the print template for its largest dimension. The process may select the smallest size sheet available in the cassette trays 490 that includes the length of the largest dimension of the print template. As will be appreciated, this aspect reduces waste in print medium resources used. The selected cassette tray 490 may feed the print medium to the paper cutting unit 470 when the cutting process is ready for execution. The paper cutting unit 470 may include one or more blades which when directed by a processor 410, may cut out a print template into a shaped page as described in the above processes. As will be appreciated, the resulting cut page shape may no longer have a perimeter size that is one of the pre-defined print medium sizes stored in the print settings, which produces a customized product for the user.

The computing device 500 may be for example, a computer system or a computer server. In some embodiments, the image forming apparatus 400 may be another example of a computing device 500. As will be appreciated, some aspects of the embodiments disclosed above may turn the computing device 500 into a special purpose computer system. For example, in the role of a host server, the computing device 500 may implement for example the functions of storing electronic image object files with connected users and their workstations. In the role of a user device, the computing device 500 is generally not a server but may instead be desktop computers, tablet or laptop computers, all-in-one computer stations, a mobile computing device (for example, a smart phone, smart wearable devices (glasses, jewelry, watches, ear wear, etc.), or programmable electronics, which may store print job files from scanned data, and which may be forwarded to a cutting unit.

The components of the computing device 500, may include, but are not limited to, one or more processors or processing units 510, a system memory 520, data storage 530, a computer program product 540 having a set of program modules 545 including files and executable instructions, and a bus system that couples various system components including the system memory 520 to the processor(s) 510. The memory storage 520 may store for example, electronic files of the image objects to be printed. In some embodiments, the processors 510 may include a processing unit dedicated to graphics and image processing (for example a graphics processing unit (GPU) or visual processing unit (VPU). As a GPU or VPU, the processor 510 may implement executable instructions focused on image processing applications (like those related to converting unrendered image content data described above) either alone or in coordination with other general processor 510 types such a CPUs, microchips, and the like.

The computing device 500 may be described in the general context of computer system executable instructions, such as the program modules 545 which represent a software embodiment of the system and processes described generally above with respect to FIGS. 1 and 2. The program modules 545 generally carry out the functions and/or methodologies of embodiments as described above. The computing device 500 may typically include a variety of computer system readable media. Such media could be chosen from any available media that is accessible by the computing device 500, including non-transitory, volatile and non-volatile media, removable and non-removable media for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. The system memory 520 could include one or more computer system readable media in the form of volatile memory, such as a random-access memory (RAM) and/or a cache memory. By way of example only, the data storage system 530 may read from and write to a non-removable, non-volatile magnetic media device. The system memory 520 may include at least one program product 540 having a set of program modules 545 that are configured to carry out the functions of embodiments of the invention in the form of computer executable instructions. The program product/utility 540 may be stored in the system memory 520 by way of example, and not limitation, as an operating system, one or more application programs, other program modules, and program data. Some embodiments may generate an electronic user interface (viewable and controllable from the display unit 450 or display 550) that may allow the user to enter image objects, text, or graphics for processing and in some embodiments, control and manipulate the image objects onto a print sheet (even though embodiments are generally considered automated and sizing/positioning may primarily be performed by the processing unit(s) 410 and/or 510).

The computing device 500 may communicate with one or more external devices including for example, an electronic display 550 which may in some embodiments be configured for tactile response as in a touch screen display. User input into the display 550 may be registered at the processor 510 and processed accordingly. Other devices may enable the computing device 500 to communicate with one or more other computing devices, either by hardwire or wirelessly. Such communication can occur via Input/Output (I/O) interfaces/ports 560. In some embodiments, the I/O interfaces/ports 560 may be specially configured to handle aspects of the embodiments described herein converting the computing device 500 into a special purpose machine. For example, as a printer, the I/O interfaces/ports 560 may be configured specifically to transmit receipt of the scanned data to a processor 510 dedicated to custom page shaping. The I/O interfaces/ports 560 may also include printing modules (for example, ink jet print heads, laser print systems, etc.) for rendering a physical embodiment of a page sheet with text and/or graphics printed thereon according to the above processes.

The computing device 500, through the I/O interface/ports 560, may communicate with one or more networks such as a local area network (LAN), a general wide area network (WAN), and/or a public network (e.g., the Internet) via a network adapter as is commonly known in the art. Each of the operating system, one or more application programs, other program modules, and program data or some combination thereof, may include an implementation of a networking environment. In some embodiments, the computing device 500 may be a cloud computing node connected to a cloud computing network (not shown). The computer computing device 500 may be practiced in distributed cloud computing environments where tasks are performed by remote processing devices that are linked through a communications network. In a distributed cloud computing environment, program modules may be located in both local and remote computer system storage media including memory storage devices. Thus, members contributing to for example, the overall system being developed described above may provide software modules to the computing device 500 which may hold electronic files and copies in more than one physical location.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” Furthermore, aspects of the disclosed invention may take the form of a computer program product embodied in one or more computer readable media having computer readable program code embodied thereon. In some embodiments, the output of the computer program product provides an electronic user interface on the display 550 which may be controlled via direct contact with the display 550 or via the I/O interfaces 560 (which may be for example, interface devices such as keyboards, touchpads, a mouse, a stylus, or the like).

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 510 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks in the figures.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method of customizing a shape of a print job using a shape from a scanned document, by a computer processor, comprising:
receiving, by the computer processor, scan data of the scanned document;
extracting, by the computer processor, an object shape from the received scan data;
saving, by the computer processor, the object shape as a print template;
receiving, by the computer processor, text or a graphic;
automatically sizing, by the computer processor, the text or graphic to fit within a boundary defined by a size of the print template;
sending, by the computer processor, the print template, including the automatically sized text or graphic, to a computer operated print cutting unit;
cutting, by the computer operated print cutting unit, the print template from a medium, resulting in a cut page shape, wherein the cut page shape includes the automatically sized text or graphic within a perimeter of the cut page shape; and
outputting the cut page shape from the cutting unit.

2. The method of claim 1, wherein the cut page shape includes a perimeter size that is not a pre-defined print medium size stored in a printer setting of the cutting unit.

3. The method of claim 1, wherein the extracted object shape is non-rectangular.

4. The method of claim 1, further comprising:
extracting, by the computer processor, dimensions of the extracted object shape; and
selecting a cassette tray coupled to the cutting unit based on a print medium size closest to the dimensions of the extracted object shape.

5. The method of claim 1, wherein the print medium is a sheet of paper.

6. A computer program product for customizing a shape of a print job using a shape from a scanned document, the computer program product comprising a non-transitory computer readable storage medium having computer readable program code embodied therewith, the computer readable program code being configured, when executed by a computer processor, to:
receive, by the computer processor, scan data of the scanned document;
extract, by the computer processor, an object shape from the received scan data;
save, by the computer processor, the object shape as a print template;
receive, by the computer processor, text or a graphic;
automatically size, by the computer processor, the text or graphic to fit within a boundary defined by a size of the print template;
send, by the computer processor, the print template, including the automatically sized text or graphic, to a computer operated print cutting unit;
cut, by the computer operated print cutting unit, the print template from a medium, resulting in a cut page shape, wherein the cut page shape includes the automatically sized text or graphic within a perimeter of the cut page shape; and
output the cut page shape from the cutting unit.

7. The computer program product of claim 6, wherein the cut page shape includes a perimeter size that is not a pre-defined print medium size stored in a printer setting of the cutting unit.

8. The computer program product of claim 6, wherein the extracted object shape is non-rectangular.

9. The computer program product of claim 6, further comprising computer readable code configured to:
extract, by the computer processor, dimensions of the extracted object shape; and
select a cassette tray coupled to the cutting unit based on a print medium size closest to the dimensions of the extracted object shape.

10. The computer program product of claim 6, wherein the print medium is a sheet of paper.

11. A multi-function device, comprising:
an electronic memory;
one or more cassette trays for holding a print medium;
an electronic scanner;
a cutting unit configured to cut a unit of the print medium;
a feeder coupled to the one or more cassette trays and configured to feed the print medium to the cutting unit; and
a computer processor coupled to the electronic memory, the electronic scanner, the cutting unit, and the feeder, wherein the computer processor is configured, when executed by instructions provided by the electronic memory, to:
receive, by the computer processor, scan data of the scanned document;
extract, by the computer processor, an object shape from the received scan data;
save, by the computer processor, the object shape as a print template;
receive, by the computer processor, text or a graphic;
automatically size, by the computer processor, the text or graphic to fit within a boundary defined by a size of the print template;
send, by the computer processor, the print template, including the automatically sized text or graphic, to a computer operated print cutting unit;
cut, by the computer operated print cutting unit, the print template from a medium, resulting in a cut page shape, wherein the cut page shape includes the automatically sized text or graphic within a perimeter of the cut page shape; and
output the cut page shape from the cutting unit.

12. The multi-function device of 11, wherein the object shape includes a perimeter size that is not a pre-defined print medium size stored in a printer setting of the multi-function device.

13. The multi-function device of claim 11, wherein the extracted page shape is non-rectangular.

14. The multi-function device of claim 11, wherein the computer processor is further configured to:
extract, by the computer processor, dimensions of the extracted object shape; and
select a cassette tray coupled to the cutting unit based on a print medium size closest to the dimensions of the extracted object shape.

15. The multi-function device of claim 11, wherein the print medium is a sheet of paper.
